(19) United States
(12) Patent Application Publication
(10) Pub. No.: US 2009/0130305 A1
(43) Pub. Date: May 21, 2009

(54) CABIN FOR COATING A WORK PIECE WITH POWDER

(75) Inventors: Leopold VON KEUDELL, Salem (DE); Michael TOPP, Oberteuringen (DE); Joachim HIRT, Uhldingen-Muhlhofen (DE); Niko ZWERGER, Friedrichshafen (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: J. WAGNER AG, Altstatten (CH)

(21) Appl. No.: 12/261,273

(22) Filed: Oct. 30, 2008

(30) Foreign Application Priority Data
Nov. 12, 2007 (EP) 07 405 324.0

(51) Int. Cl. B05D 1/12; B05C 21/00

(52) U.S. Cl. 427/180; 118/309

(57) ABSTRACT

A cabin for coating a work piece with powder has horizontal suction channels provided in the lower area of the side walls of the cabin, such horizontal suction channels can be covered with flaps. Furthermore, a vertical suction channel is provided with suction openings, whereas the suction openings connect the inner part of the cabin with the vertical suction channel.

### CROSS-REFERENCE TO RELATED APPLICATION

The present application claims priority under 35 U.S.C. §119 to European Patent Application No. 07 405 324.0, filed on Nov. 12, 2007, the entire disclosure of which is incorporated herein by reference.

### TECHNICAL FIELD

The present invention relates to a cabin for coating a work piece with powder.

### DESCRIPTION OF THE RELATED ART

In order to coat a work piece such as a plate or a cabinet with powder, the powder is sprayed into a powder coating cabin onto the work piece with the aid of one or more powder spray guns. The powder can be charged electrostatically so that the powder sticks better to the work piece by means of a high voltage. One must, however, ensure that the powder in the cabin does not exceed a certain concentration otherwise there is a risk of an explosion. This is why the air, which is in the cabin, along with the powder, which has not stuck to the work piece, the so-called overspray, is continuously sucked out. There is also a partial vacuum generated in the cabin in a way which ensures that no powder leaks out of the cabin.

A further reason why excess powder is already being removed from inside the cabin during operation is that the cleaning measures required for changing powder colour are performed in much less time if the cabin had already had most of the excess powder removed during coating operations.

A powder spray coating cabin is known from the relevant art described in DE 103 50 332 A1, where the cabin floor consists of a number of flaps. The flaps are arranged parallel to each other. If the flaps are in a horizontal position, a slit is created between the flaps through which excess powder is sucked into a suction channel located below the flaps. The flaps can be turned into a vertical position to be in a position to clean the suction channel, so that the suction channel becomes accessible from above. This solution does, however, have the disadvantage that the operating personnel cannot enter the cabin floor, which is made up of the flaps. It is therefore a lot more difficult to manually clean the inside of the cabin. The fact that air is sucked out through the suction channel located under the flaps during the coating operation also means that the powder, which is already subjected to the force of gravity, is also sucked downwards towards the floor of the cabin. This means that the work piece to be coated receives less powder at the top and therefore even more at the bottom. This makes it a lot more difficult to coat the work piece with an even coating thickness over its whole height and to achieve the same coating efficiency overall.

A cabin for coating a work piece with powder is known from the relevant art described in EP 1 125 639 B1. The cabin is fitted with an accessible floor, whereby there is a slanting wall located between each side wall of the cabin and the floor, and such slanting wall, together with the side wall and the floor, creates a suction channel in the lower corner area of the cabin. The slanting wall has a suction slit in it over which excess powder gathering on the floor can be sucked into the suction channel.

A powder coating cabin is known from the printed document U.S. Pat. No. 6,821,346 B2 in which a suction channel is located below an accessible floor fitted with suction slits. There is a slanting wall located between the side walls of the cabin and the floor from which the accumulated excess powder can be blown downwards towards the floor with the aid of air blowing nozzles located in the side wall. This configuration of the lower area of the cabin is complex to make and also has the disadvantage that the powder, which is already subjected to the force of gravity, is also accelerated in its movement downwards towards the floor of the cabin by the suction. This can lead to the work piece being coated with more powder at the bottom than at the top.

### SUMMARY OF THE INVENTION

An object of the invention is to provide a cabin for coating a work piece with powder with which a constant coating efficiency can be achieved over the whole height of the work piece. This means that the even coating of the work piece with powder should be made possible over its whole height.

The cabin according to invention for coating a work piece with powder is fitted with horizontal suction channels in the lower area of the cabin side walls, and such suctions channels can be covered with cover elements. There is also a vertical suction channel with suction openings, whereby the suction openings connect the inside of the cabin with the vertical suction channel. The term coverable used below is to be understood as meaning partially or fully coverable.

Advantageous further developments of the invention arise from the features given in the dependent patent claims.

The vertical suction channel is connected to the horizontal suction channel in one further embodiment of the cabin according to invention.

A door is fitted with suction openings in an additional embodiment of the cabin according to invention, whereby the vertical suction channel is accessible via the door.

The width of the opening and/or the number of suction openings in the door can increase towards the top.

Additionally or alternatively, a suction slit can also be placed between the door and the side wall of the cabin.

The horizontal suction channels on the cabin according to invention can advantageously be integrated into the side walls of the cabin and closed off flush with the inner sides of the cabin side walls. This prevents excess powder from depositing.

It is also of advantage when a suction slit can be provided in the cabin according to invention between the side walls of the cabin and the cover element. If powder has accumulated on the floor, the static friction must be overcome in order to suck the powder from the floor into the suction slit. Not only the excess powder immediately accessible on the floor but also the excess powder which is already far up in the cabin can be sucked out of the cabin through the suction slit above the cover element.

Additionally or alternatively, a suction slit can also be placed between the cover element and the cabin floor in the cabin according to invention. The suction of excess powder through this suction slit is particularly effective when the air blowing bar located on the floor facilitates the cleaning of the floor using compressed air.

A further suggestion to solve the object is that a drive can be provided into the cabin according to invention which can actuate the cover element. Controlling of the drive takes place by means of a dedicated control unit. This means that the degree of automation can be increased even further.

One can arrange in the cabin according to invention that the cover element is a flap and that the rotary axis of the flap is located in the middle of the flap. This means, advantageously, that less force is needed to move the flap. This is particularly advantageous if air is sucked out through the suction slit above and below the flap because an additional force acts on the flap due to the air pressure.

One can also plan to fit the cover element with a number of cover element sections which can be opened and closed independently of each other. Actuation of the cover element sections can be coupled with actuation of the air blowing bar sections.

In one further development of the cabin according to invention it is planned to have the cabin fitted with an opening for a powder spray gun, whereby this opening and the suction openings can be located opposite to each other in the vertical suction channel. The suction openings planned in the door or the suction slits located on the side of the door ensure that not only powder which has reached the floor, but also the powder which is higher up in the cabin can be sucked out.

A further feature of the invention allows this process to be improved even further by locating a manual coater platform before or after the cabin.

A collection channel can be provided under the cabin floor to which the suction channels are attached to.

It is also possible to arrange for the horizontal suction channels to be connected via the vertical suction channels to a collection channel.

It is furthermore possible to arrange for the horizontal suction channels to be connected to a suction device and for the vertical suction channels to be connected to a further suction device.

It is alternatively possible to arrange for the vertical suction channel and the horizontal suction channel to open out into a common collection channel.

It is furthermore possible to arrange for the vertical suction channels to be connected via the horizontal suction channels to a common collection channel.

It is furthermore possible to fit an air blowing bar on the cabin floor. Thus further improves cleaning of the cabin floor.

In one further development of the cabin according to invention, a collection channel is located under the cabin floor and such collection channel connects the suction channels with a suction device.

In one embodiment of the cabin according to invention the air blowing bar is split into a number of sections, whereby the sections may be actuated independently of each other. This means that a good cleaning effect can be achieved with a relatively small amount of air.

A method is finally suggested for operating the cabin for which the suction takes place during the coating operation via the vertical suction channels and during a change of colour via both the horizontal and the vertical suction channels.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention is further explained below on the basis of a number of example embodiments shown in the 8 figures.

FIG. 1 shows the cabin according to invention in a schematic diagram in a sectional view from the front.

FIG. 2 shows the cabin according to invention in a sectional view from the top.

FIG. 2a shows a further embodiment of the cabin according to invention in a sectional view from the top.

FIG. 3 shows a three-dimensional view of a part of the cabin according to invention.

FIG. 4 shows in a sectional view how the horizontal and vertical suction channel opens out into a common collection channel.

FIG. 5 shows one first possible embodiment of the horizontal suction channel in a sectional view.

FIG. 6 shows a second possible embodiment of the horizontal suction channel in a sectional view.

FIG. 7 shows a third possible embodiment of the horizontal suction channel in a sectional view.

FIG. 8 shows the actuation of the air blowing bar in a schematic diagram.

### DETAILED DESCRIPTION OF THE INVENTION

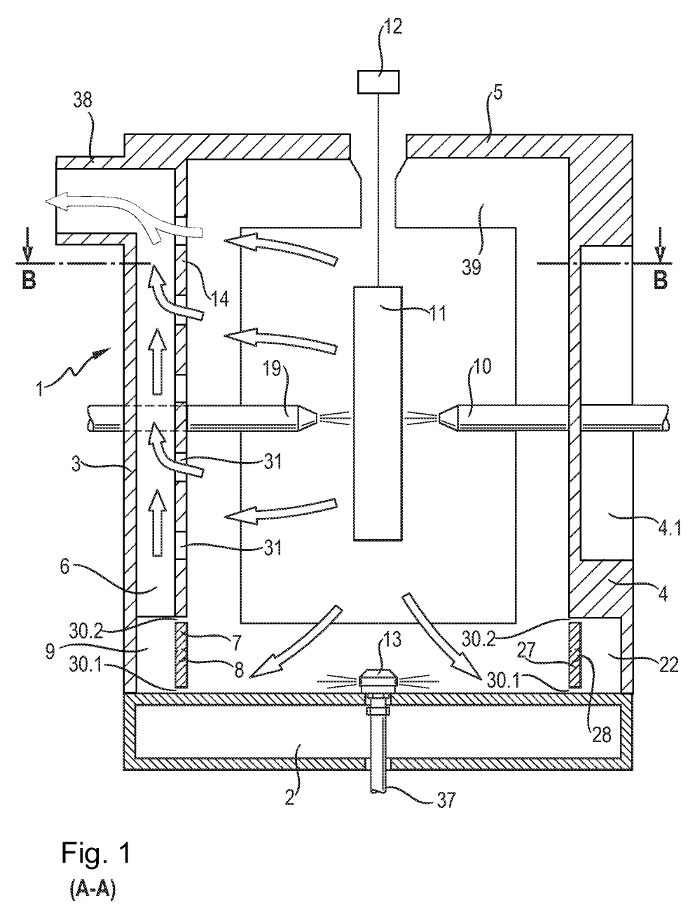

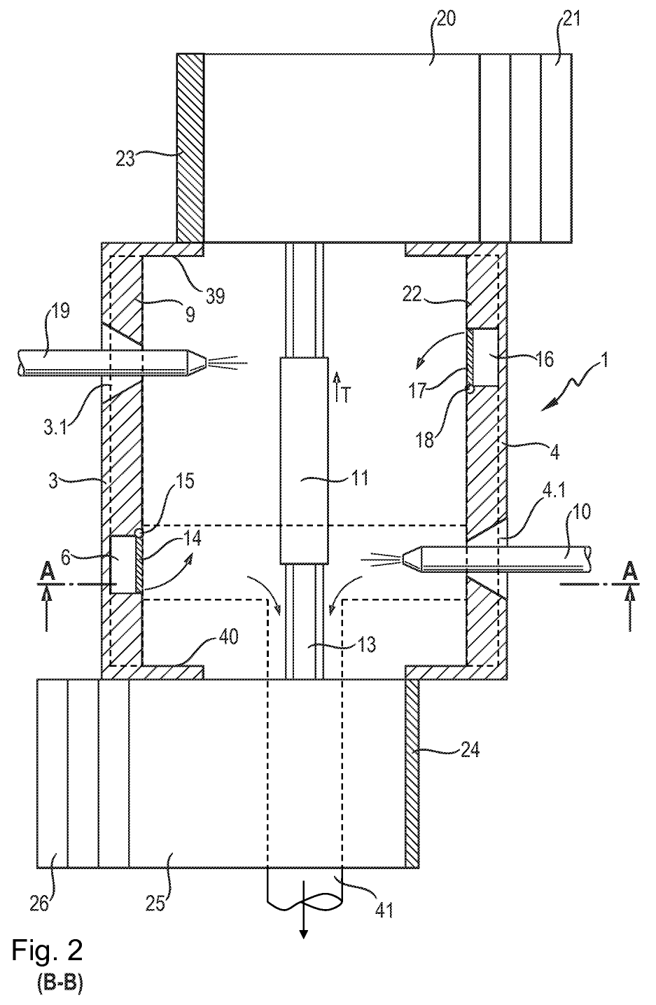

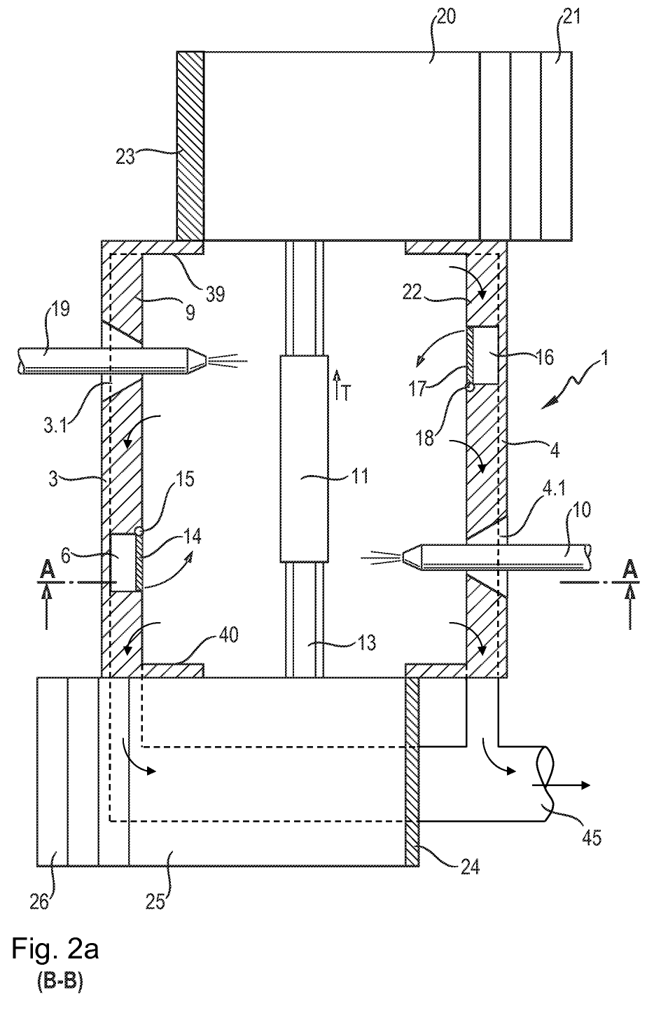

FIG. 1 shows a first embodiment of the cabin 1 according to invention for coating a work piece 11 with powder in a sectional view from the front. The work piece 11 is transported through the cabin 1 with the aid of a conveying device 12 and sprayed on its front and rear side with powder with the aid of two spray guns 10 and 19. In FIG. 2 the cabin 1 according to invention is shown in a sectional view from the top. The first powder spray gun 10 projects through an opening 4.1 into the side wall 4 into the interior of the cabin 1. Displaced to the side for that purpose the second powder spray gun 19 projects through an opening 3.1 into the side wall 3, also into the interior of the cabin 1.

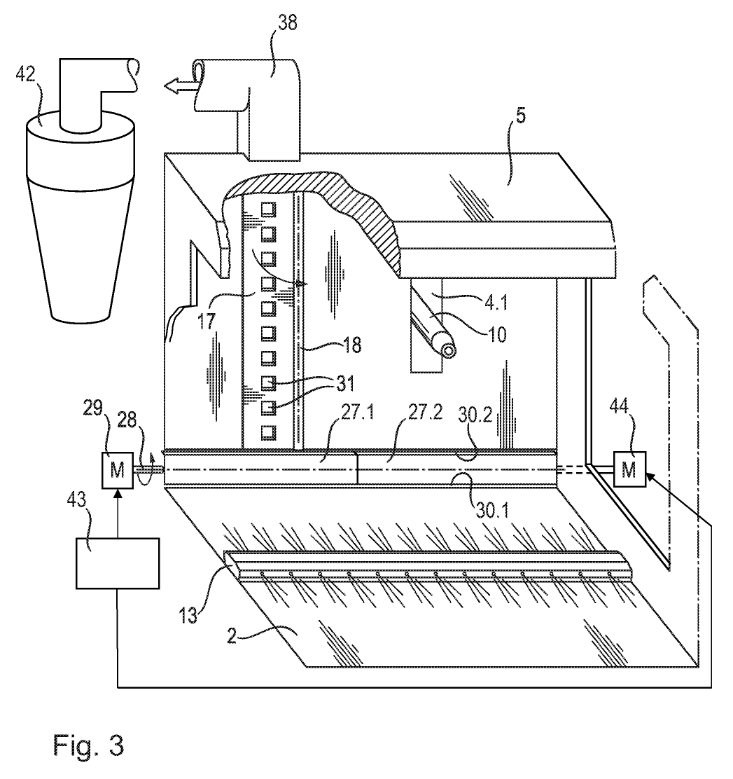

There is a vertical suction channel 6 opposite the powder spray gun 10 and the opening 4.1 and located in the side wall 3 which can be at least partially closed off by a door 14. The door 14 is connected for this purpose with the side wall 3 via a hinge 15. The door 14 has one or more suction openings 31 over which excess powder, that is powder which has not stuck to the work piece 11, can be sucked out of the cabin 1 again. In the embodiment shown in FIG. 3, the suction openings 31 are located distributed over the whole height of the door 17. The widths of the opening and/or the number of suction openings 31 can be increased from the bottom towards the top to optimize the suction.

There is a suction channel 9 running horizontally in the lower area of the cabin 1 which can be partially closed via a flap 7 which can be rotated around a rotary axis 8. The horizontal suction channel 9 is integrated, for the embodiments shown in FIGS. 1 to 3, into the side wall 3 of the cabin 1. The flap 7 is located in such a way that it is aligned with the inner side of the side wall 3 in the closed condition (see FIG. 1). A suction slit 30.2 is located between the inner side of the side wall 3 and the upper edge of flap 7 through which excess powder can be sucked out of the cabin 1 into the suction channel 9. There is a suction slit 30.1 between the lower edge of flap 7 and the cabin floor 2 through which excess powder can be sucked out of the cabin 1. According to the design shown in FIGS. 2 and 3, the channel 9 essentially stretches over the whole length of the cabin 1.

The excess powder which has found its way into the floor area of the cabin 1 is sucked through both suction slits 30.1 and 30.2 into the channel 9 and from there into the vertical suction channel 6. From there the powder passes through a collection channel 38 which is located, as shown as in the embodiment in FIG. 1, in the upper area of the cabin 1, to a suction device 42 located outside the cabin 1. The suction device 42 could be, for example, a filter or a cyclone such as that shown schematically in FIG. 3.

A further vertical suction channel 16 is located in the side wall 4, opposite the opening 3.1 in the side wall 3 and the spray gun 19, and such vertical suction channel 16 is at least partially closable using a door 17. The vertical suction channels 6 and 16 as well as the doors 14 and 17 are identically built as shown in the embodiment in the FIGS. 1 to 3. The door 17 is connected to the side wall 4 over a hinge 18.

One further horizontally running suction channel 22, which is at least partially closable over a flap 27, is located in the lower area of side wall 4. The flap 27 can be rotated around a rotary axis 28. There is a suction slit 30.1 located between the floor 2 and the lower edge of the flap 27 over which excess powder can be sucked into the horizontal channel 22. There is a further suction slit 30.2 located between the upper edge of flap 27 and the side wall 4 over which overspray can also be sucked into the suction channel 22. The suction channels 9 and 22 as well as the flaps 7 and 27 are basically identically built. The suction channel 22 is connected to the vertically running suction channel 16.

The cabin 1 has a front wall 40 on the front side and a wall 39 on the rear side in order to reduce the size of the opening of the cabin. Both walls 39 and 40 create a type of sluice so that less air is sucked into the cabin.

FIG. 2a shows a further embodiment of the cabin according to invention in a view from above in a cross-section. This embodiment differs from the embodiment shown in FIG. 2 due to the location of the suction system. The vertical suction channel 6 opens out into the horizontal suction channel 9 and this in turn opens out into a collection channel 45. The vertical suction channel 16 opens out into the horizontal suction channel 22 and this in turn opens out into the collection channel 45. The powder then finds its way from there to the suction device 42.

Part of the cabin 1 according to invention is shown in FIG. 3, in a three dimensional view. In this presentation the flap 27 includes two flap sections 27.1 and 27.2 which can be moved independently of each other. The rotary axis 28 for flap section 27.1 is connected to a drive 29, for example an electric motor. The rotary axis for flap section 27.2 is connected to a further drive 44. Drives 29 and 44 can be used to move the flap sections 27.1 and 27.2 into various positions, independently of each other. If, for example, flap section 27.1 is brought into a horizontal position then the section of suction channel 22 located behind it becomes accessible to the operating personnel and can be cleaned manually by them. The same applies analogously for the flap 7 and the suction channel 9.

A collection channel 41 can be located below the cabin 1 (see FIG. 2) in order to lead the powder sucked through the channels 6, 16, 9 and 22 to the external suction device 42. The vertical suction channel 6 in this embodiment is connected with the collection channel 41 via the horizontal suction channel 9. Also the vertical suction channel 16 is connected with the collection channel 41 via the horizontal suction channel 22. The collection channel 41 leads in turn to the suction device 42.

Instead of the collection channel 41 located under the cabin 1 it is also possible to have a collection channel 38 located at the top on the cabin 1. The horizontal suction channel 9 in this embodiment is connected with the collection channel 38 via the vertical suction channel 6. Also the horizontal suction channel 22 is connected with the collection channel 38 via the vertical suction channel 16. This in turn leads the excess powder to the suction device 42.

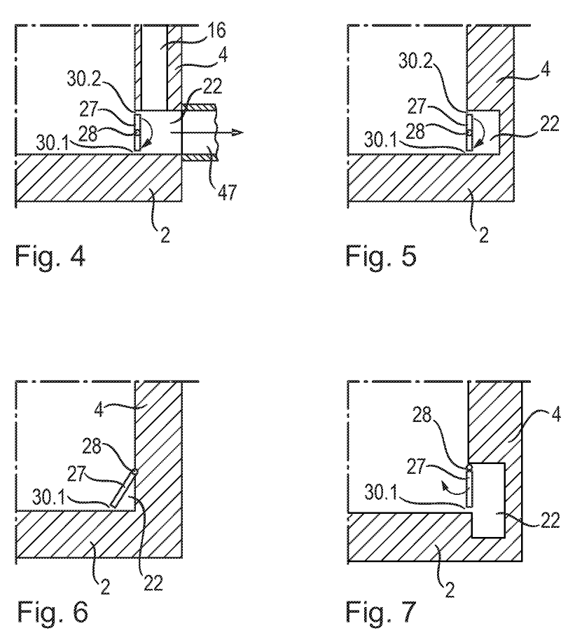

In the embodiment according to FIG. 4 the vertical suction channel 16 and the horizontal suction channel 22 open out together into a collection channel 47. This is connected in turn with the suction device 42.

There are various embodiments of the horizontally running suction channel 22 shown in FIGS. 5, 6 and 7. The suction channel 9 is shown accordingly.

For the embodiment shown in FIG. 6, the horizontal suction channel 22 is not integrated into the side wall 4 but instead projects into the inner part of the cabin 1. The flap 27 is connected at the top with the cabin side wall 4 via the hinge 28, lies below on the floor 2 and creates a slanting surface. There is a suction slit 30.1 located between the lower edge of the flap 27 and the floor 2. The flap 27 together with the side wall 4 and the floor 2 creates the horizontal suction channel 22.

In the embodiment shown in FIG. 7, a part of the horizontal suction channel 22 in embedded into the side wall 4 and the other part into the floor 2. The rotary axis 28 is located at the upper end of the flap 27. The rotary axis 28 can also, alternatively, be located in the middle of the flap 27.

The suction channels 6, 9, 16 and 22 can be made out of metal, preferably stainless steel, to avoid the depositing of powder on the suction channels. The design of the suction channels 6, 9, 16 and 22 made out of metal also has the advantage that powder particles which could be electrostatically charged can be discharged by the electrically conductive metal.

The suction channels 6, 9, 16, 22 are shown in the FIGS. 1 to 8 with a rectangular cross-section. The suction channels can also have a round cross-section however. The features of the embodiments shown in the FIGS. 1 to 8 can also be combined with each other.

An insert or a slide can be used instead of the flap 7 to cover the suction channel 9 and to make it accessible as required. The insert can, for example, be designed in such a way that it can be inserted by the operating personnel in the side wall and can also be taken out again. The same applies analogously for the flap 22. The cover is also called a cover element.

As shown in FIG. 2, a manual coating platform 20 or 25 can be located at the exit and/or at the entrance of the cabin 1. The personnel can step up onto the manual coating platform 25 over a stairway 26 and onto the manual coating platform 20 over a stairway 21. There is a wall 23 at the rear side of the manual coating platform 20. There is a wall 24 at the rear side of the manual coating platform 25.

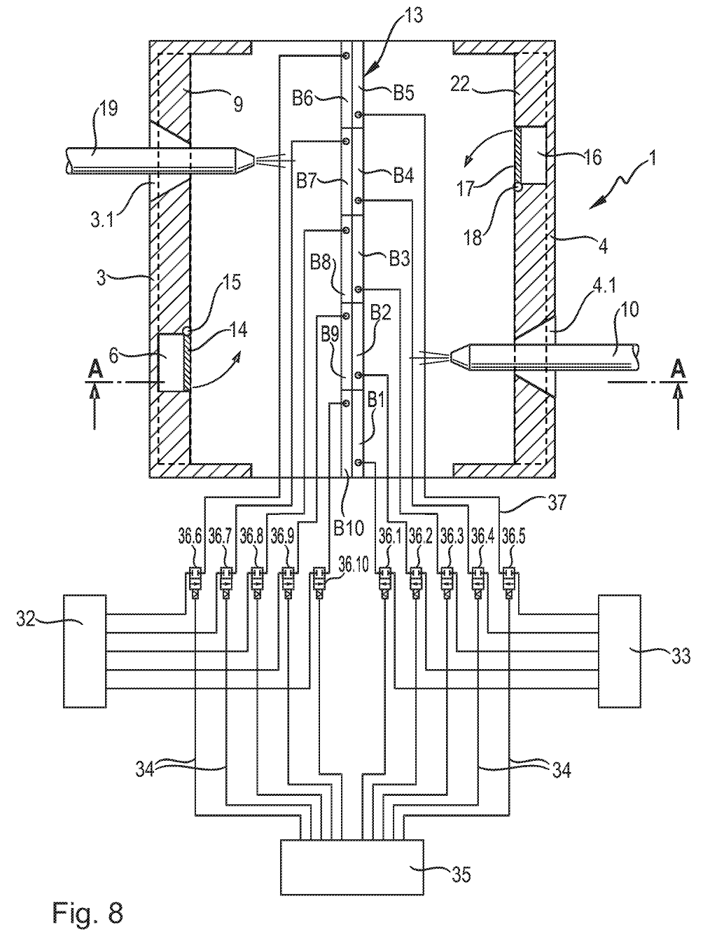

The powder coating cabin 1 in FIG. 8 is shown in a view from above together with actuation of the individual sections B1 to B10 of the air blowing bar 13. The two manual coating platforms 20 and 25 are not shown in FIG. 8. The air blowing bar 13 located in the middle of the floor 2 is supplied from below with compressed air via compressed air hoses 37. The floor 2 has for that purpose corresponding holes for the reception of the compressed air hoses 37. Compressed air is blown in an essentially parallel direction to the floor 2 in the direction of the suction openings 30.1 with the aid of the air blowing bar 9 located on the floor 2. The floor 2 can be freed from excess powder in this way.

The air blowing bar 13 having the air blowing bar sections B1 to B10 stretches over the whole length of the floor 2. The horizontal suction channels 9 and 22 lead out of the cabin 1 and transport the excess sucked off powder via a common suction channel 41 to a powder container or a cyclone separator 42, for example. Each air blowing bar section B1 to B10 of the floor air blowing bar 13 is supplied separately with compressed air via a control valve 36.1 to 36.10. For example the valve 36.1 supplies the air blowing bar section B1 while valve 36.4 supplies the air blowing bar section B4. The fact that there are a total of 10 air blowing bar sections B1 to B10 available means that 10 control valves 36.1 to 36.10 are provided. In the embodiment shown in FIG. 7, the control valves 36.1 to 36.5 obtain the required compressed air via a first compressed air vessel 33, while the control valves 36.6 to 36.10 obtain their compressed air via a second compressed air reservoir vessel 32. The controlling of the valves 36.1 to 36.10 takes place via a control unit 35 which is connected, via the corresponding control lines 34, with the valves 36.1 to 36.10.

The construction of the air blowing bar 13 is described in more detail in the registered utility model paper DE 203 05 947.6.

The floor 2 can be made with a surface covered in synthetic material, for example PVC, in order to avoid adhesion of the excess powder to the floor.

The preceding description of the embodiments according to the present invention is used only for illustrative purposes and not for the purpose of restricting the invention. Different alterations and modifications are possible within the framework of the invention without leaving the scope of the invention and its equivalents.

List of reference signs

| | |
|---|---|
| 1 | Cabin |
| 2 | Cabin floor |
| 3 | Side wall |
| 3.1 | Gun slit |
| 4 | Side wall |
| 4.1 | Gun slit |
| 5 | Cover |
| 6 | Suction channel |
| 7 | Flap |
| 8 | Rotary axis |
| 9 | Suction tube |
| 10 | Spray gun |
| 11 | Work piece |
| 12 | Conveying line |
| 13 | Air blowing bar |
| 14 | Door |
| 15 | Angel |
| 16 | Suction channel |
| 17 | Door |
| 18 | Hinge |
| 19 | Spray gun |
| 20 | Manual coating platform or control platform |
| 21 | Stairs |
| 22 | Suction channel |
| 23 | Rear wall |
| 24 | Rear wall |
| 25 | Manual coating platform |
| 26 | Stairs |
| 27 | Flap |
| 27.1 | Flap section |
| 27.2 | Flap section |
| 28 | Rotary axis |
| 29 | Drive |
| 30.1 | Suction slit |
| 30.2 | Suction slit |
| 31 | Openings |
| 32 | Control unit |
| 33 | Control unit |
| 34 | Control lines |
| 35 | Control unit |
| 36.1-36.10 | Control valve |
| T | Transport direction |
| 37 | Compressed air line |
| 38 | Suction channel |
| 39 | Front wall |
| 40 | Front wall |
| 41 | Collection channel |
| 42 | Suction device |
| 43 | Control unit |
| 44 | Drive |
| 45 | Collection channel |
| 47 | Collection channel |

1. A cabin for coating a work piece with powder, comprising:
a first and a further horizontal suction channel located in a lower area of side walls of the cabin,
cover elements with which the suction channels can be covered, and
a vertical suction channel with suction openings which connect the inner part of the cabin with the vertical suction channel.

2. The cabin according to claim 1,
wherein the vertical suction channel is connected with one of the horizontal suction channels.

3. The cabin according to claim 1,
wherein a door is provided with which the vertical suction channel can be closed off, and
wherein the suction openings are located in the doors.

4. The cabin according to claim 1,
wherein the width of the opening and/or the number of the suction openings increases towards the top.

5. The cabin according to claim 1,
wherein the horizontal suction channels are integrated into the side walls of the cabin and close off with the inner sides of the side walls of the cabin.

6. The cabin according to claim 1,
wherein a suction slit is provided between the side wall of the cabin and the cover element.

7. The cabin according to claim 1,
wherein a suction slit is provided between the floor of the cabin and the cover element.

8. The cabin according to claim 1,
wherein a drive is provided with which the cover element can be actuated, and
wherein a control unit is provided for controlling the drive.

9. The cabin according to claim 1,
for which the cover element is designed as a flap, and
wherein the rotary axis of the flap is located in the middle of the flap.

10. The cabin according to claim 1,
wherein the cover element comprises a number of independently movable of each other cover element sections.

11. The cabin according to claim 1,
wherein an opening is provided for a powder spray gun, whereby the opening and the suction openings are located opposite to each other in the vertical suction channel.

12. The cabin according to claim 1,
wherein a manual coating platform is provided.

13. The cabin according to claim 1,
wherein a collection channel is provided under the cabin floor to which the suction channels are connected.

14. The cabin according to claim 1,
wherein the horizontal suction channels are connected via the vertical suction channels to a collection channel.

15. The cabin according to claim 1,
wherein the horizontal suction channels are connected with a suction device, and
wherein the vertical suction channels are connected with a further suction device.

16. The cabin according to claim 1,
wherein the vertical suction channel and the horizontal suction channel open out into a collection channel.

17. The cabin according to claim 1,
wherein the vertical suction channels are connected via the horizontal suction channels to a collection channel.

18. The cabin according to claim 1,
wherein an air blowing bar is provided on the floor of the cabin.

19. The cabin according to claim 18,
wherein the air blowing bar comprises a number of sections which can be actuated independently of each other.

20. A method for operating a cabin according to claim 1,
wherein the suction takes place via the vertical suction channels during the coating operation, and
wherein the suction takes place via the horizontal and vertical suction channels during a change of colour.
